(19) United States
(12) Patent Application Publication
(10) Pub. No.: US 2018/0293567 A1
(43) Pub. Date: Oct. 11, 2018

(54) A CHECKOUT COUNTER AND A REGISTRATION AREA OF A CHECKOUT COUNTER

(71) Applicant: PeoplePos Ltd., London (GB)

(72) Inventor: Kay SELJESETH, Bærums Verk (NO)

(73) Assignee: PeoplePos Ltd., London (GB)

(21) Appl. No.: 15/766,675

(22) PCT Filed: Sep. 30, 2016
(86) PCT No.: PCT/IB2016/055850

§ 371 Date: Apr. 6, 2018

(30) Foreign Application Priority Data
Oct. 8, 2015 (NO) 20151340

(51) Int. Cl. G06Q 20/20; G07G 1/00; G06Q 30/06

(52) U.S. Cl. CPC G06Q 20/208; G07G 1/0054; G06K 9/00355; G07G 1/009; G06Q 30/06

(57) ABSTRACT

The present invention discloses a checkout counter which includes loading areas, registration area and packing area, where the registration area comprises means for motion detection and optionally parallel checkout and registration of purchased goods where the means at least comprises: a first registration zone, a second registration zone, and at least one registration means adapted to register goods from the first and the second registration zone, and a packing area configured to receive goods from two registration zones in parallel.

### TECHNICAL FIELD

The present invention relates to registration area of a checkout counter and checkout counters as such.

### BACKGROUND ART

A typical checkout counter (ref. FIG. 1a) in use in retail stores includes a loading area, a registration area and a packing area. The loading area may be provided with conveyor belts which convey goods from the loading area and into the registration area. At the registration areas goods are traditionally registered by a cashier. The registration process may include the use of automatic scanning equipment such as bar code readers operated by the cashier. The next zone is the packing area; goods are either conveyed or manually fed from the registration area to the packing area.

Recently, self-service checkout counters have been introduced. Their layout and design usually resembles that of the traditional checkout counter shown in FIG. 1a. However the customer is then exchanged with the cashier and a payment zone/area is added. The customer then loads the goods into the loading area or directly into the registration area where the goods are registered. After all goods have been registered the customer swipes a debit card or credit card in a card reader thereby finishing the transaction process between the goods provider and himself.

A problem with prior art check-out counters manual and self-service alike, is the possibility of erroneous scanning of goods.

It is known from U.S. Pat. No. 6,540,137 B1 a checkout terminal which provides self-service registration of goods as well as operator registration of goods by reconfiguring the checkout terminal between the two modes, i.e. self-service and operator driven.

U.S. Pat. No. 5,752,582 disclose a checkout station which allows a single cashier to assist multiple customers simultaneously.

It is an object of the present invention to overcome the drawbacks related to possible erroneous registration of goods.

### DISCLOSURE OF INVENTION

It is one object of the invention to provide a technical solution to increase registration security while still maintaining the inherent registration capacity/speed of registration zones for check-out counters.

More particularly it is disclosed a registration area of a checkout counter, comprising means for independently parallel checkout and registration of purchased goods where the means at least comprises:

a first registration zone,
a second registration zone adjacent and parallel with the first registration zone, and
at least one registration means adapted to register goods from the first and the second registration zone simultaneously or substantially simultaneously. Where the registration area of the checkout counter further comprises:
a first registration means adapted to register goods from the first registration zone, and
a second registration means adapted to register goods from the second registration zone. Moreover in one aspect the first registration zone includes a first scale and/or the second registration zone includes a second scale.

In yet an aspect the first and the second registration zone comprises driving means for conveying goods. According to one aspect the driving means are provided as rollers in the first and the second registration zone adapted to facilitate transport of goods.

In yet an aspect the registration means includes at least one of:

a barcode scanner, an RFID-scanner and optical/visual recognition devices.

It is disclosed a registration area of a checkout counter,

comprising at least one means for motion detection.

The at least one means for motion detection is provided as one of or a combination of: passive infrared sensors, microwave detection sensors, ultrasonic sensors, Tomographic motion detector, video camera software, or laser light sensor.

In one aspect of the registration area of the checkout counter comprises:

a first means for motion detection, and
a second means for motion detection.

In one aspect the registration area of a checkout counter additionally comprises means for parallel checkout and registration of purchased goods where the means at least comprises:
a first registration zone,
a second registration zone, and
at least one registration means adapted to register goods from the first and the second registration zone.

In one aspect the registration area of the checkout counter comprises:

a first registration means adapted to register goods from the first registration zone, and
a second registration means adapted to register goods from the second registration zone.

Finally it is provided a complete checkout counter which includes loading areas, registration area and packing area according to the above. In particular it is provided a checkout counter comprising:

a loading area configured to forward goods downstream to a registration area comprising two registration zones,
the registration area comprising means for parallel checkout and registration of purchased goods where the means at least comprises:
a first registration zone,
a second registration zone, and
at least one registration means adapted to register goods from the
first and the second registration zone, and
   a packing area configured to receive goods from the two registration zones.

It is also disclosed a method for operation of a checkout counter, where said method comprises the steps of:

a) to transport item to a shared zone of the roundtable,
b) check if ongoing sale is complete, and if so continue at point c), and if not continue at point d
c) move barrier from sensor point to the opposite position, continue with point g,
d) check if customer has completed his registrations, and if so continue at point e), and if not continue at point b
e) move customer side barrier to centre position, the cashier continues registering items,
f) check if ongoing registration from cashier is complete, if not continue with point e, if yes continue with point c, and
g) continue with a new customer repeating the steps a-g.

According to the present invention it is also disclosed a checkout counter comprising:
a loading area,
comprising at least one means for motion detection, and
a packing area configured to receive goods from at least one registration zones.

The checkout counter can further comprise:
a loading area,
a registration area comprising means for parallel checkout and registration of purchased goods where the means at least comprises:
   a first registration zone,
   a second registration zone, and
   at least one registration means adapted to register goods from the first and the second registration zone, and
   a packing area configured to receive goods from two registration zones in parallel.

In one aspect the loading area comprises a rotatable roundtable disc with at least one barrier arranged radially from the centre of the disc.

In another aspect of the checkout counter the packing area comprises a rotatable disc with at least one barrier arranged radially from the centre of the disc.

Other advantageous features will be apparent from the accompanying claims.

### BRIEF DESCRIPTION OF DRAWINGS

Following is a brief description of the drawings in order to make the invention more readily understandable, the discussion that follows will refer to the accompanying drawings, in which

FIG. 1a shows a prior art checkout counter;

FIG. 1b shows a checkout counter with one motion sensor;

FIG. 1c shows a checkout counter with two motion sensors;

FIG. 1d shows a checkout counter with two motion sensors

FIG. 2a shows a general view of a checkout counter with two motion sensors according to the present invention;

FIG. 2b shows a general view of a checkout counter with two motion sensors seen from above,

FIG. 3a-d shows embodiments of registering zones with motion sensors according to the present invention,

FIG. 4a-d shows embodiments of packing area with a roundtable according to the present invention,

FIG. 5a-b shows embodiments of packing area with a standard configuration according to the present invention,

FIG. 6a shows embodiments of loading area with a standard configuration according to the present invention,

FIG. 6b-e shows embodiments of loading area with a roundtable according to the present invention,

FIG. 7a-d shows operation of the packing area utilizing a roundtable according to embodiments of the present invention,

FIG. 8 shows operation of the packing area utilizing a standard packing area configuration according to embodiments of the present invention,

FIG. 9 shows I/O devices, electronic devices and registering devices in communication with a computer system according to one embodiment of the present application.

FIG. 10 shows a flow chart for operation of a checkout counter according to one aspect of the invention,

FIG. 11 shows a flow chart for operation of a checkout counter according to another embodiment of the invention.

### MODE(S) FOR CARRYING OUT THE INVENTION

In the following it is firstly disclosed general embodiments in accordance with the present invention, thereafter particular exemplary embodiments will be described. Where possible reference will be made to the accompanying drawings and where possible using reference numbers in the drawings. It shall be noted however that the drawings are exemplary embodiments only and other features and embodiments may well be within the scope of the invention as described.

In the following description it will be adhered to the definitions below:
Cashier, by a cashier it is meant any person that operates the checkout counter and is responsible for the cashier terminal during expedition of customer goods.
Customer, the customer shall be interpreted as any person which have the intention of purchasing goods and which brings the goods to a checkout counter according to the present invention.
Checkout counter, and counter is used interchangeably throughout the description. The terms shall be understood as the complete check area for checking out goods that is the loading area, the registration area including any cash register and the packing area.
Scale, by scale it shall be understood any scale being a part of a checkout counter which is configured for weighing goods that shall be checked out by the checkout counter. Any input from these are read into a computer system and registered into the applicable zone according to the computer system state and logic.
Registration means, by registration means it shall be understood any means adapted to register goods. Typical examples include bar code scanners, RFID-readers or optical/visual recognition devices. The registration means may be configured to scan/register goods in a plurality of direction; this can be facilitated by using a rotating scanning head, RFID-reader and/or optical registration unit(s). Any input from these are read into a computer system and registered into the applicable zone according to the computer system state and logic.
Loading area, the loading area is defined as the area in which customers place goods to be purchased.
Cashier screen, this is the primary information source for the cashier, where the cashier may see the registration status, barrier sensor status, the sales line per sale/registration, the payment status and any counter system information needed to control and operate the counter. The screen may be a touch screen, allowing combined visual screen output and touch input against the screen. The touch input may be used instead of, or in addition to the cashier keyboard/input device(s). The screen should be directed towards the cashier in such a way that it is easy visible and also reachable in the case of a touch screen. Other output information may be given using light signals, audible output and other known means of human interaction.
Cashier keyboard/input devices: The functions supported by the cashier keyboard and input device(s) will be the same as for any typical point of sale/counter computer system keyboard/input. In addition the keyboard and/or cashier input device(s) will support features for controlling the registration in the applicable zones, open and close sales, control the barrier(s), perform customer zone assistance, perform customer zone registrations on demand and allow the cashier to control the system as required.
Customer screen: This is the primary information source for the customer, where the customer may see the registration status for the ongoing sale, the sales lines, the payment status and other information required by the customer to perform registrations according to the state of the system in the customer zone. Typically the screen may inform the customer that registrations may be performed, a registration has been accepted, a registration needs to be done by the cashier, a registration is paused/denied due to regulatory conditions or that the zone used is closed. The screen may be a touch screen, allowing combined visual screen output and touch input against the screen. The touch input may be used instead of, or in addition to the cashier keyboard/input device(s). The screen should be directed towards the customer in such a way that it is easy visible and also reachable in the case of a touch screen. Other output information may be given using light signals, audible output and other known means of human interaction.
Customer keyboard/input devices: The keyboard and/or customer input device(s) will support features for supporting the customer registration process in the customer zone, like to confirm or select options needed to be input to the computer system.
Packing zone barrier sensors/activators: The computer system may execute operational control from knowing the position of the barriers at any time of the processing. The sensors may through the means of known technology like magnetic switches, micro switches, optical sensors or other means detect if a barrier is present in a sensor position, what barrier is present or if it has been moved passed the sensor position and then in what direction.
Banking terminal: One or more banking terminals may be attached to the computer system to facilitate integrated payment operations. These may be customer self-service operated and/or cashier operated according to the implementation desired.
Motion sensor: The motion sensors according to the present invention can be based on light, laser beams, photo barriers among others. The sensors can be provided as one of or a combination of (dual technology motion detectors or multi-technology motion detectors), Area Reflective Type, Passive infrared sensors, Microwave detection sensors, Ultrasonic sensors (Sends out pulses of ultrasonic waves and measures the reflection off a moving object), Tomographic motion detector or Video camera software and colour sensors. The Area Reflective Type sensor emits infrared rays from an LED and uses the reflection of those rays, the sensor measures the distance to the object and detects if the object is within a designated area. Colour sensors can be used as an additional detector to for instance identify human skin. Video camera software are programs that monitors video signals from cameras. It is able to detect if a significant part of the picture has changed; i.e., it can detect motion.

Erroneous registration of goods at checkout counters is a problem. Customers may deliberately or by accident cover codes to be registered, such as bar codes, QR-codes or other “visual” codes. Double registration may also occur etc.

Means which have the ability to sense motion of arms and/or hands can provide additional certainty when scanning/registering goods at a checkout counter. Motion detectors can be supported by optical colour sensors for detecting human skin and/or they can be supported by temperature detecting devices such as infrared temperature measurement devices. Infrared sensors are noncontacting and they infer temperature by measuring the thermal radiation emitted by a material.

Video cameras used for detection of motion is essentially a combination of camera hardware including any camera motors for manipulating camera position and software for processing of images received from the cameras. In principle motion detection in its simplest form includes a comparison between pixels in two or more subsequent digital images. Unchanged pixels between subsequent digital images indicate that “nothing has happened” whilst changed pixels indicates a change. By analysing numerous subsequent pictures in a row a pattern of movement can be predicted and also the object or objects that have moved can be predicted. The latter for example by comparison with known pattern, i.e. the pixel pattern off sudden objects and particular movements have been taught to the system, i.e. processor and memories. In an adaptive system a library of pixel pattern associated with particular objects and/or movements will be built over time.

Mathematic analyses of expected pixel patterns based on previous patterns may help in the analyses of received image data from the one or more cameras. Obviously a combination of cameras and laser scanners or LIDAR's can be used for motion detection.

Motion recognition can be an integral part of the registration means, registration means such as optical scanners may be configured to additionally detect motion. The registration means and the motion sensors may be based on different technology, but still be housed within the same cabinet/housing. Motion recognition/detection/scanning can be effected by photographic analysis, measurement of returned light in the divided zones, in that one or more photo barriers wrap or similar methods commonly known for detecting a movement beyond a point or region. The movement direction may also be determined by the motion detectors.

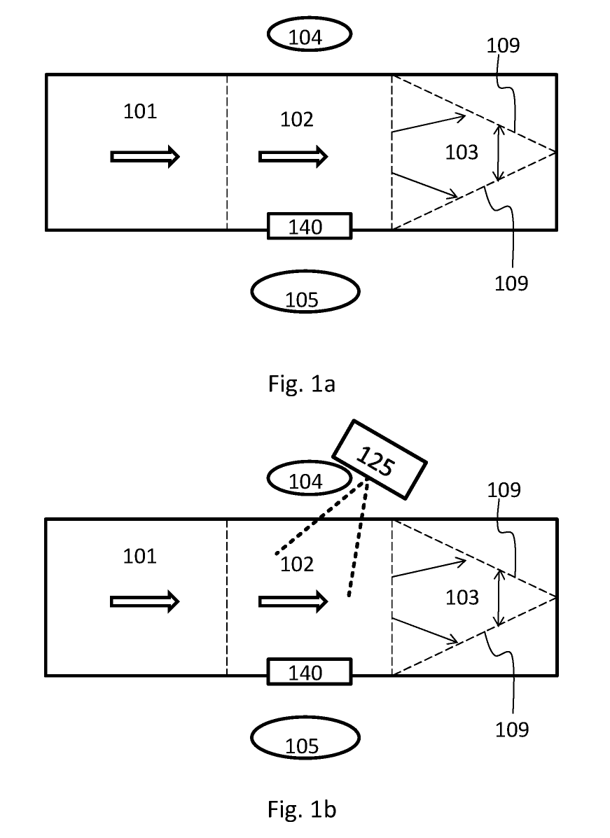

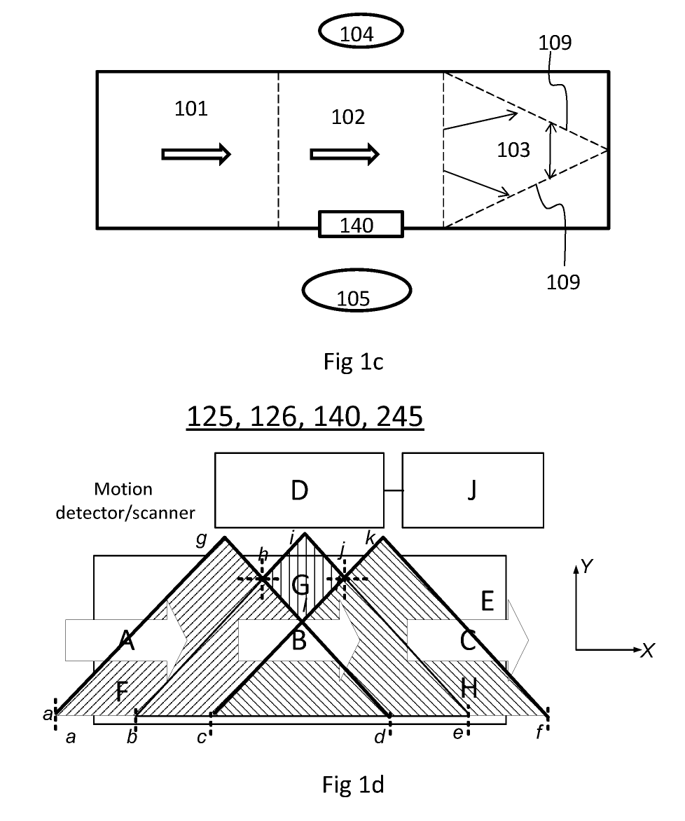

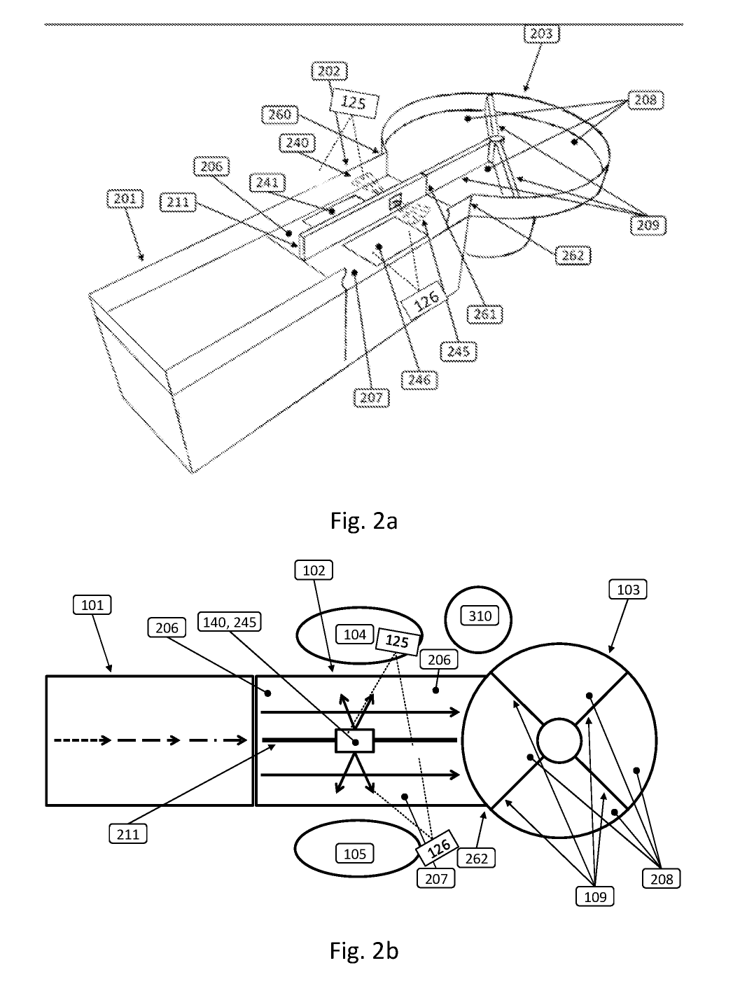

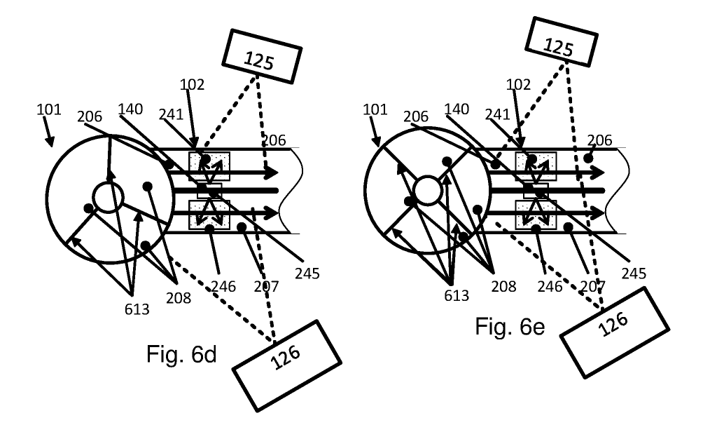

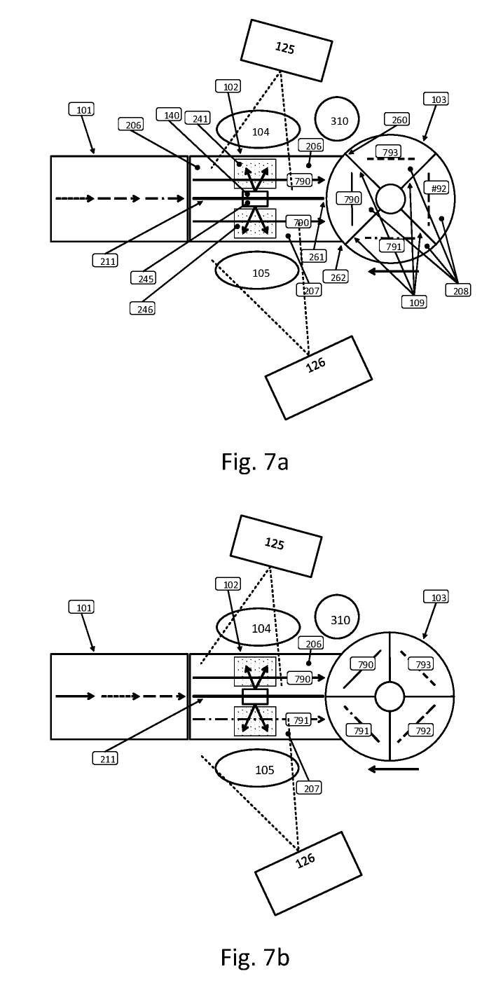

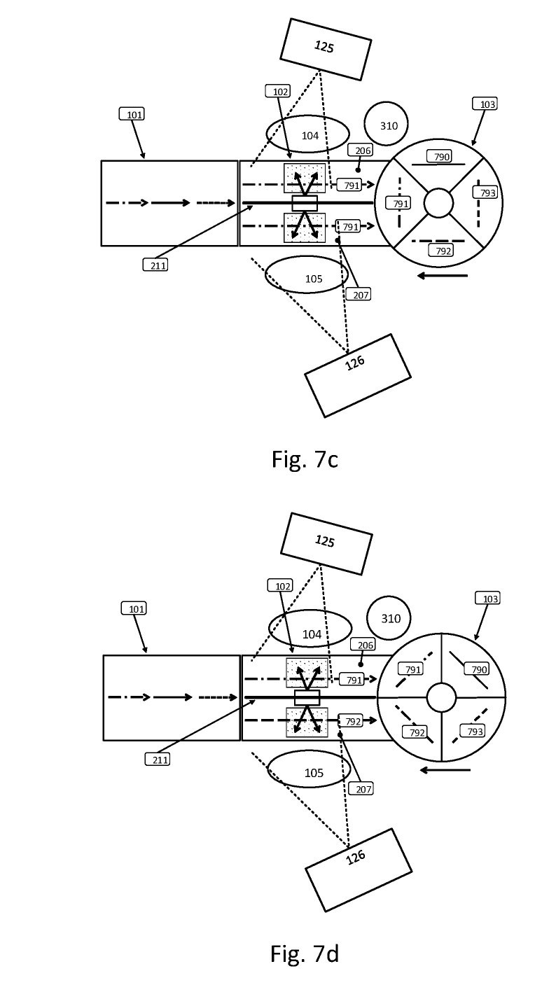

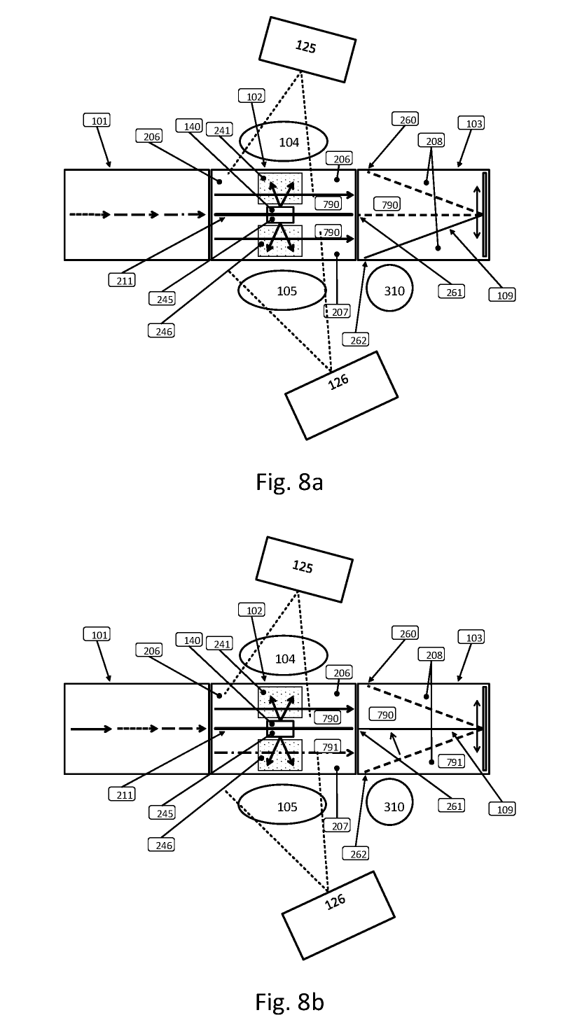

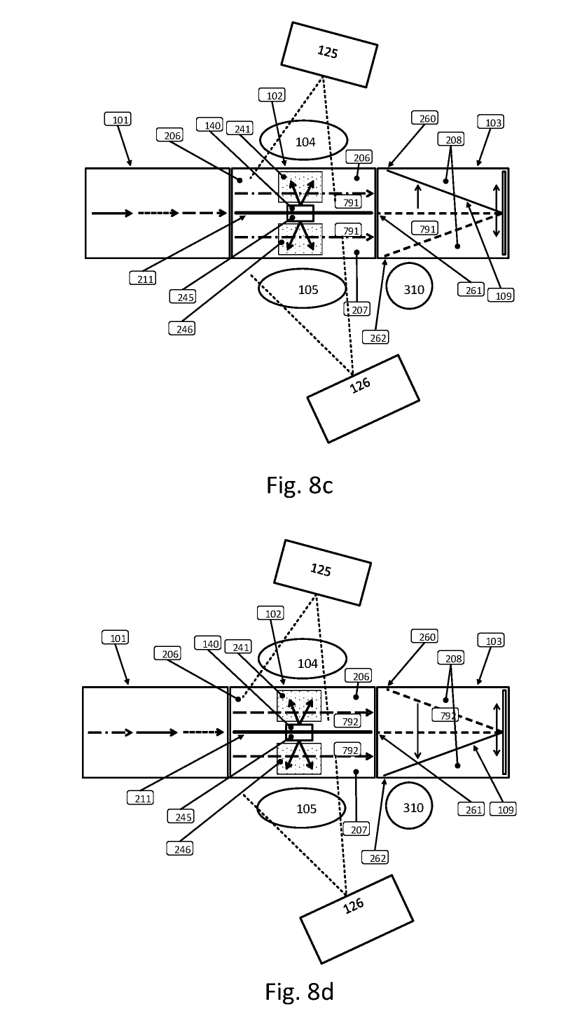

The product scanning/registration as such is described below with reference to FIGS. 3-8, for illustrative purposes a scanning beam for registering goods is labelled “G” the combined scanning device (registration means) and motion detector, is marked “D”. As is illustrated in among others FIGS. 1b, c, 2a and 2b the motion detectors 125, 126 can be separate from the registration means moreover the checkout counter may include one, two or more separate motion detecting means.

A restricted area within the registration area of a checkout counter is suitable for the detection of motion. An example of such an area is indicated as E in FIG. 1d, whereas the whole registration area shown in FIG. 3a-d can be suitable for motion detection. The motion detection area can be found immediately before any common barcode reader/goods registration means or near another item detection unit.

Upon detection of a motion indicating that an item is moved through the detection area E, the system will check that a commodity detection have been carried out and registration of goods between the entrance to the detection area marked “A” and the exit of the detection area indicated by the arrow marked “C”. The control can alternatively be carried out using one or more sensors, where aggregate information regarding motion/movement and identification/registration of goods are compared or grouped together so as to reveal whether goods are registered correctly or an item is moved past the registration zone without being registered, as indicated above

A signal indicating the status of registration can be provided using light signals, audio signals and/or the registration status is transferred to other systems (payment station/system), so that the customer and/or cashier and/or other required recipients of the information can access it.

In one embodiment the customer can get a red light at the erroneous/missing registration and cashier gets a notice of the same on his screen. Correspondingly a correct registration can trig a green light and the item shows up in the payment system as being correctly registered. Obviously indication of erroneous registration and correct registration may be indicated differently from what is mentioned above, the goal is to indicate erroneous and correct registration in a manner which can be handled by the operators of the registrations means, such as the cashier.

A typical checkout counter comprises three areas, the present counter differs in the way the centre area 102 is designed. In particular so by the introduction of one or more motion detectors 125, 126. In accordance with embodiments of the present invention the centre area, registration zone 102, is combined with packing area 103 and loading area 101. The centre area is the registration area. According to one embodiment in addition to the typical cashier's registration means the checkout counter according to the present invention is provided with a second parallel registration zone 207 that can be used by a customer in such a way that they can independently register their own goods against their own purchases. In another embodiment the registration zone is a self-service zone which includes one or more motion detectors 125, 126.

The registration area can be built up with one or two roller paths or conveyor belts. These may be operating freely or synchronously between the customer and cashier. Any feed mechanism may be controlled manually or via a computer system, typically referred to as the Point of Sale (POS) system.

The registration area is designed to transmit item registrations from each of two fields into each of their ongoing purchase registrations, or to combine the registrations into a single purchase, into a POS system or in such a way that one or more zones can be in a payment queue after they are completely registered. This enables the registration process to continue with one or more outstanding payments related to purchases in the packing area.

The checkout counter can be fitted with a turntable packing area 103, which allows for multiple purchases to accumulate in zones 208 according to the output from the registration area 102. The turntable packing area 103 may have zones 208 of varying/flexible size in order to be adaptable to varying package volumes per purchase. Also, the position of these zones can be read into the POS system so that the registration/scanning process is stopped or only allowed into the correctly set zone, based on zones positioned against the registration area and the respective detection zones.

The payments may be self-serviced or performed as any common payment performed by the cashier. For example, a customer could pay his buy/zone with his payment cards on his own, while another customer pays for his purchases/zone to the cashier.

According to one embodiment of the invention it is provided a POS system that can simultaneously manage sales for at least the number of concurrent checkout zones that the counter is physically built to handle. The cashier will through the POS system have full overview of all the zones, any ongoing registrations per zone and any ongoing or closed sales and payments. The cashier may also according to desired security settings verify, change or delete registrations made per zone.

The POS system may have logic for random control of customer registrations per an arbitrary number of registrations to reduce the risk of fraud and erroneous registrations, in the same way as common in so-called self-scanning checkout solutions. Also regulatory controls can be made, like verifying the customer's age when needed and for limiting sales outside an allowable time period.

The first area, called the “loading” area 101 may according to one embodiment be designed as a rotatable unit or roundtable disc which physically resembles a rotatable disc in the packing area 103 or be single rollers based or use conveyor belt. The loading area 101 is directly in communication with the registration area 102 registration zones 206, 207.

### A Practical Example of Motion Detection

Returning to FIG. 1d, a practical example of motion detection with three optical detectors will be described.

The area marked as “D” in the figure indicates a combined scanner and two laser/light rays (“F” and “H”) for motion detection. It shall be appreciated that one or more extra laser/light rays can be added for motion detection. The number of motion detectors is partly governed by the design, layout and size of the registration area and the interface between the registration area and the packing area. The combination of commodity registration/identification and detection/identification of the movement of one or more arms utilises motion detectors. Correct registration of goods either by a customer or a cashier can be verified by a combined registration and motion recognition system according to the present invention. By way of illustration a sequence of registration can be shown as a binary shift as is shown in table 1 below. The detection areas can be divided into detection zones as is illustrated in FIG. 1d. The detection areas of the motion detectors in FIG. 1d is indicated as the detection zones F and H whilst in this example a combined registration and motion detector is associated with a detection zone G, the mentioned detection zones can be defined as the following triangles:
Detection zone F: a, g, d
Detection zone G: b, i, e
Detection zone H: c, k, f

The detection zones F, G and H overlap to create the following combined detection zones:
E1=a, g, h, b: F only
E2=b, h, l, c: F and G
E3=h, i, j, l: G only
E4=c, l, d: F and G and H
E5=d, l, j, e: G and H
E6=e, j, k, f: H only

If a commodity is moved from left side in FIG. 1d following the arrows A-C the commodity will pass several combined detection zones creating a pattern which as mentioned above can be illustrated as a bit pattern. A commodity will in this example enter the motion detector scanning area E on the left side and leave the area on the right side of FIG. 1d whilst the movement of an arm which grabs or moves commodities will have a different movement and thereby create a different bit pattern signature. Table one below shows a bit pattern for a commodity passing cross points in the following order: E1, E2, E4, E5, E6.

TABLE 1
Commodity travelling in X-direction, i.e. velocity component Vx.

| | Passing «Points» | | | | | | | | |
|---|---|---|---|---|---|---|---|---|---|
| | E1 | E2 | E3 | E4 | E5 | E6 | F | G | H |
| Initial | X | X | X | X | X | X | X | X | X |
| a, g | 1 | | | | | | 1 | | |
| b, h | | 1 | | | | | 1 | 1 | |
| c, l | | | | 1 | | | 1 | 1 | 1 |
| l, d | | | | | 1 | | | 1 | 1 |
| j, e | | | | | | 1 | | | 1 |
| k, f | X | X | X | X | X | X | X | X | X |

Open boxes or X, can be any of «1», «0» or “Z” dependent on configuration.

By configuring a CPU one can teach the CPU “correct” and “wrong patterns”. The table does not take into account the speed of the commodity or an arm movement. Obviously a speed component in both X (Vₓ) and y (Vy)-direction can be calculated, and thereby a “real” speed vector.

$$Vx = \frac{dx}{dt} , Vy = \frac{dy}{dt} ; and V = \sqrt{( {Vx}^{2} + {Vy}^{2} )}$$

By combining speed pattern calculation with the bit pattern signature one can in a reliable way indicate erroneous and correct scanning of goods. The simple layout of detection zones E1-E6 above gives 64 different bit patterns (2⁶), adding the speed component will increase the reliability. Moreover, if the goods are conveyed by a conveyor belt they will typically have a known speed, V_{X}, before being manually handled or before they end up in “congestion” due to too many goods on the conveyor belt.

A system as indicated above which not only detects motion but the character—speed and direction—of the motion can typically be configured adaptively. That is, one can teach a CPU with memory valid and not valid bit pattern signatures and speed component signatures.

In a more primitive version the system can be semi adaptive or fixed. The latter will use fixed logic circuitry which is preprogramed by a manufacturer/vendor, ASICS can be a candidate for use in a fixed system. A semi adaptive system can include FPGAS which have to be programmed by technicians/service personnel.

The speed of a conveyed commodity can be calculated by knowing distances (ds={square root over ((dx²)}+dy²)) between measure points (ref calculation of velocity components above), the timing between measure points can be calculated by counting a number of clock cycles of a system clock.

By adding additional motion detectors one can achieve even more reliable motion detection data—adding one motion detector doubles the possible combinations (in this example from 2⁶ to 2⁷).

It shall be noted that the practical example is a simplified example and in practical life a single laser barcode scanner or omnidirectional laser scanner can be configured to be used in a motion detecting mode, for example periodically after a sudden number of clock pulses. A laser barcode scanner uses a single laser source which in combination with a moving mirror or prism generate a “line” of light. This line of light can be used to detect moving objects by reading reflected light sent from the barcode scanner. An omnidirectional bar code scanner is in principal a number of single laser barcode scanners arranged in for example a star shaped fashion. The omnidirectional scanner may be used as a motion detecting device on its own or in combination with other motion detecting means 125, 126.

### First Embodiment of the Registration Area

The first embodiment (FIG. 3a) of the registration area discloses a registration area 102 of a checkout counter with parallel processing of goods including two adjacent and parallel registration zones 206, 207 and one registration means adapted to register goods in both registration zones 206, 206 simultaneously or substantially simultaneously. The registration area is further provided with one motion detector 125, 126.

In a variant of the first embodiment it is provided two motion detectors 125, 126 one for the cashier and one for a second person, such as a customer.

### Second Embodiment of the Registration Area

According to a second embodiment (FIG. 3b) of the present invention the registration area 102 according to the first embodiment of the registration zone is provided with at least one scale 241, 246.

### Third Embodiment of the Registration Area

The third embodiment (FIG. 3c) of the registration area discloses a registration area of a checkout counter with parallel processing of goods including two adjacent and parallel registration zones 206, 207 and two registration means 140, 245 adapted to register goods in both registration zones simultaneously or substantially simultaneously.

### Fourth Embodiment of the Registration Area

According to a fourth embodiment (FIG. 3d) of the present invention the registration area 102 according to the third embodiment of the registration area is provided with at least one scale 241, 246.

The second, third and fourth embodiments of the registration areas can be combined with one, two or more motions detectors.

### First Embodiment of the Packing Area

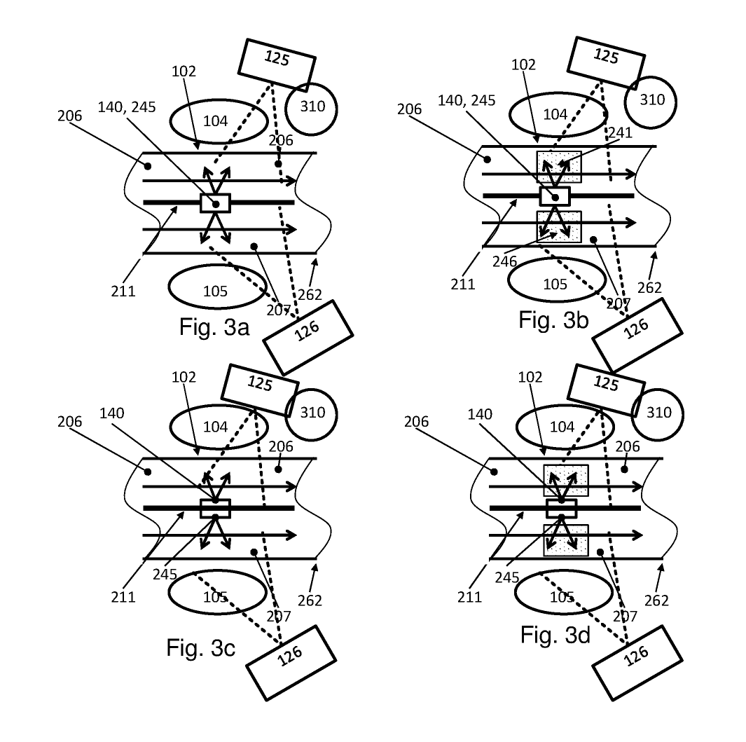

The first embodiment (FIG. 4a) of the packing area discloses a packing area 103 of a checkout counter with parallel processing of goods including a rotatable disc a so called turntable packing area arranged with one barrier 109 arranged radially from the centre or proximately to the centre of the disc. The one barrier 109 is adapted to rotate synchronously and/or together with the rotatable disc as well as independently of the disc around its axis of rotation i.e. the centre or proximately the centre of the disc. It shall be noted that the packing area is configured to receive goods from two registration zones (206, 206, and 207,207) in parallel.

### Second Embodiment of the Packing Area

The second embodiment (FIG. 4b) of the packing area discloses a packing area 103 of a checkout counter with parallel processing of goods including a rotatable disc arranged with two barriers 109 arranged radially from the centre or proximately to the centre of the disc where the two barriers 109 is adapted to rotate synchronously and/or together with the rotatable disc as well as independently of the disc around its axis of rotation i.e. the centre or proximately the centre of the disc. According to one aspect of the second embodiment of the packing area the two barriers 109 are parallel and arranged radially from the centre or proximate to the centre of the disc in opposite directions.

### Third Embodiment of the Packing Area

The third embodiment (FIG. 4c) of the packing area discloses a packing area 103 of a checkout counter with parallel processing of goods including a rotatable disc arranged with three barriers 109 arranged radially from the centre or proximately to the centre of the disc where the three barriers 109 is adapted to rotate synchronously and/or together with the rotatable disc as well as independently of the disc around its axis of rotation i.e. the centre or proximately the centre of the disc. The angle between the barriers 109 will typically be 120°.

### Fourth Embodiment of the Packing Area

The fourth embodiment (FIG. 4d) of the packing area discloses a packing area 103 of a checkout counter with parallel processing of goods including a rotatable disc arranged with four barriers 109 arranged radially from the centre or proximately to the centre of the disc where the four barriers 109 is adapted to rotate synchronously and/or together with the rotatable disc as well as independently of the disc around its axis of rotation i.e. the centre or proximately the centre of the disc. The angle between the barriers 109 will typically be 90°. However, according to aspects of the fourth embodiment the angle between barriers may vary as the barriers may move independently of the rotatable disc and hence the angle between adjacent barriers may vary. A solution with four barriers may for example include the angles 180°, 60°, 60° and 60°. Hence the angle between to neighbouring barriers may be 180° or 60°.

The person skilled in the art will realise that the number of barriers may exceed four.

### Fifth Embodiment of the Packing Area

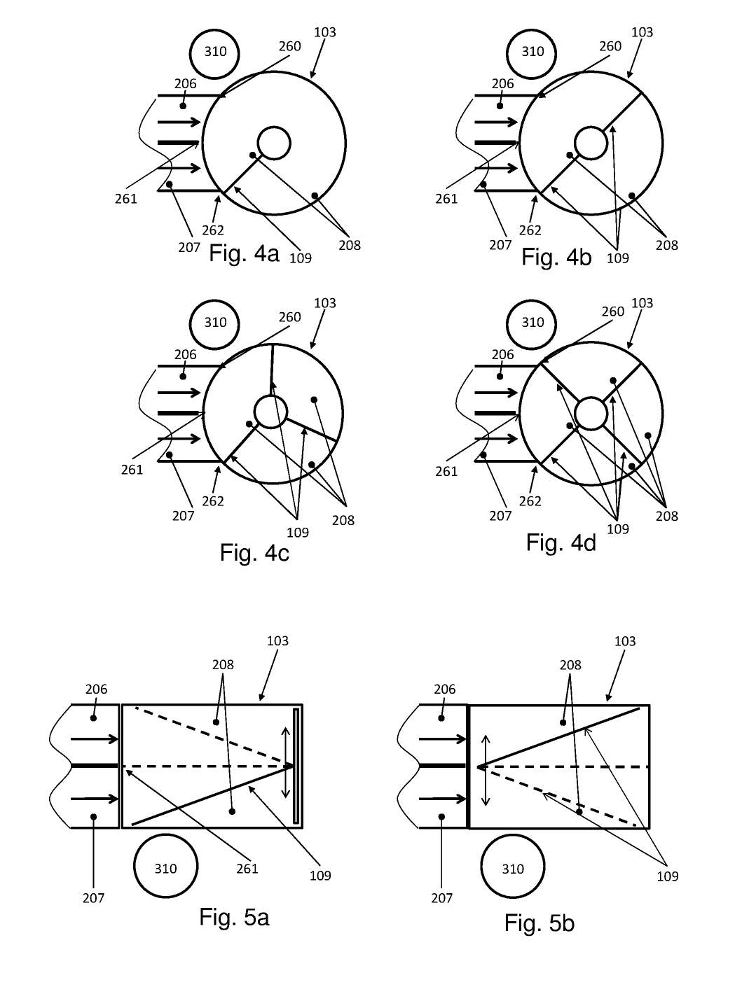

The fifth embodiment (FIG. 5a-b) of the packing area discloses a packing area 103 of a checkout counter with parallel processing of goods. This embodiment is often referred to as a standard packing area. The packing area according to this embodiment is designed as a parallelepiped. The packing area comprises one barrier 109 pivotally arranged at the centre or substantially in the centre of one end of the packing area. The barrier is adapted to divide the packing area into two zones, where the border of the zones will depend on the position of the barrier. Typically the barrier may be moved between three position which will give three different configured packing zones for the barrier pivotably connected to the remote end of the packing area (FIG. 5a) and three for a barrier connected to the near side (FIG. 5b) of the packing area respectively. The nearside of the packing area is the part of the packing area which is adjacent to the registration area, and the remote end of the packing area is the end which is farthest from the registration area.

According to the invention each single embodiment of the registration area may be combined with any embodiment of the packing area.

### A First Embodiment of the Loading Area

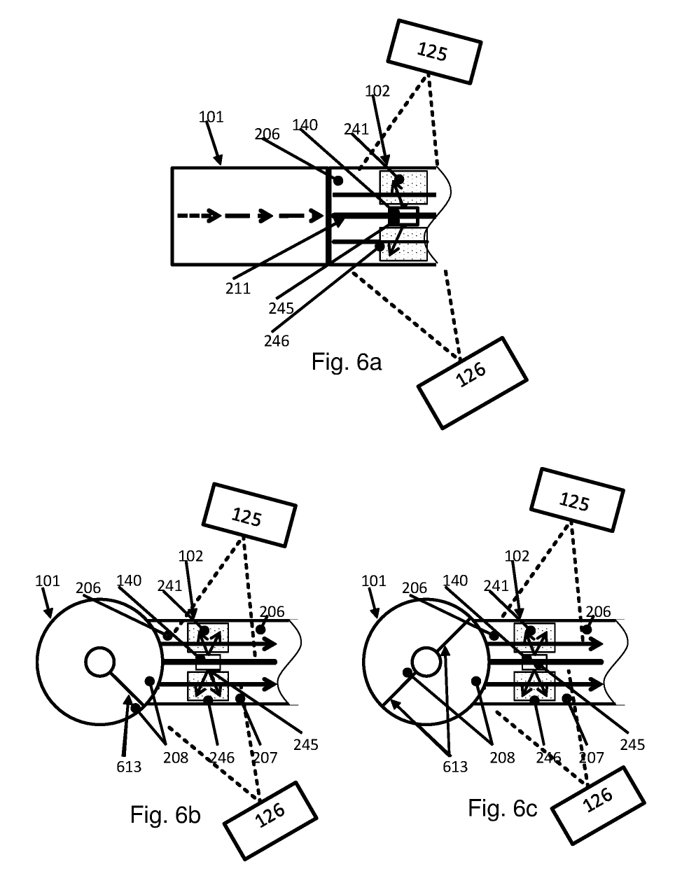

According to a first embodiment (FIG. 6a) of the loading area 101, the loading area is a surface with a perimeter that is substantially a parallelepiped. The perimeter of the surface may be provided with sidewalls running along at least one side of the perimeter of the parallelepiped shaped surface. In one embodiment the sidewall runs along all sides of the surface apart from a part of the surface which is arranged adjacent to the registration area.

The loading area may be provided with rollers or one or two conveyor belts.

### A Second Embodiment of the Loading Area

According to a second embodiment (FIG. 6b-d) of the loading area 101, the loading area is provided with a disc which resembles that of the first (FIG. 6b), second (FIG. 6c), third (FIG. 6d) and fourth (FIG. 6e) embodiment of the packing area. It may also be provided as a disc without any barrier. The perimeter of this embodiment is substantially circular.

According to one aspect of the second embodiment of the loading area the barriers are pivotably movable around its axis of rotation independent of the disc. Moreover, as further discussed elsewhere the barriers may be provided with sensors and the turntable with activators which are configured to interact with the barriers so as to facilitate or prevent movement of the barriers 613 and/or the roundtable disc.

The person skilled in the art will realise that configurations with a number of barriers as described with respect to the packing area may also be utilised for the loading area.

The person skilled in the art will realise that all embodiments of the loading, registration and packing areas may be combined into one checkout counter according to the present invention. It shall be noted that the loading area is configured to forward goods downstream to two registration zones (206, 207) in a registration area in parallel.

| | |
|---|---|
| 101: | Loading area |
| 102: | Registering/scanning area |
| 103: | Packing area |
| E | Motion detection area |
| F: | First detection zone defined by triangle a, g, d in FIG. 1d |
| G: | Second detection zone defined by triangle b, i, e in FIG. 1d |
| H | Third detection zone defined by triangle c, k, f in FIG. 1d |
| E1 | First “combined” detection zone defined by a, g, h, b part of |
| | first detection zone F only in FIG. 1d |
| E2 | Second combined detection zone defined by b, h, l, c part of |
| | first detection zone F and second detection zone G in FIG. 1d |
| E3 | Third “combined” detection zone defined by h, i, j, l part of |
| | second detection zone G only in FIG. 1d |
| E4 | Fourth combined detection zone defined by c, l, d part of first |
| | detection zone F, second detection zone G and third detection |
| | zone H in FIG. 1d |
| E5 | Fifth combined detection zone defined by d, l, j, e part of |
| | second detection zone G and third detection zone H in FIG. 1d |
| E6 | Fifth combined detection zone defined by e, j, k, f part of third |
| | detection zone H only in FIG 1d. |
| 104: | Cashier |
| 105: | Customer performing registering/scanning |
| 206: | Cashier registering/scanning zone |
| 207: | Customer registering/scanning zone |
| 208: | Packing zone(s) |
| 109: | Packing zone barriers |
| 310: | Payment station |
| 211: | Barrier between registering zones |
| 613: | Loading zone barriers |
| 919: | Computer/processing unit |
| 125 | Motion detecting means |
| 126 | Motion detecting means |
| 140: | Cashier operated barcode scanner |
| 241: | Cashier operated scale |
| 245: | Customer operated barcode scanner |
| 246: | Customer operated scale |
| 260: | Cashier side packing zone barrier sensor + activator |
| 261: | Center barrier packing zone barrier sensor + activator |
| 262: | Customer side packing zone barrier sensor + activator |
| 970 | Cashier screen/touch screen |
| 971 | Cashier keyboard/IO panel |
| 972 | Customer screen/touch screen |
| 973 | Customer keyboard/IO panel |
| 790: | Sales sequence/Blue zone |
| 791: | Sales sequence/Yellow zone |
| 792: | Sales sequence/Green zone |
| 793: | Sales sequence/Red zone |
| CPU | Central Processing Unit |
| ASIC | Application Specific Integrated Circuits |
| FPGA | Field Programmable Gate Array |

1. Registration area of a checkout counter comprising at least one means for motion detection, where at least one of the means for motion detection detect if a significant part of detection zones on the registration area are interfered where the detecting zones partly overlap and creates combined detecting zones, each detecting zone is associated with one means for motion detection.

2. Registration area of a checkout counter according to claim 1, where aggregate information regarding motion/movement and identification/registration of goods are compared or grouped together so as to reveal if goods are registered correctly.

3. Registration area of a checkout counter according to claim 1, further comprising a signal means indicating the status of registration using light signals, audio signals and/or the registration status is transferred to other systems (payment station/system), so that the customer and/or cashier and/or other required recipients of the information can access it.

4. Registration area of a checkout counter according to claim 1, the at least one means for motion detection is provided as one of or a combination of: passive infrared sensors, microwave detection sensors, ultrasonic sensors, Tomographic motion detector, video camera software, or laser light sensor.

5. Registration area of a checkout counter according to claim 1, where the registration area of the checkout counter comprises:
a first means for motion detection, and
a second means for motion detection.

6. Registration area of a checkout counter according to claim 1, comprising means for parallel checkout and registration of purchased goods where the means at least comprises:
a first registration zone,
a second registration zone, and
at least one registration means adapted to register goods from the first and the second registration zone.

7. Registration area of a checkout counter according to claim 1, wherein the registration area of the checkout counter comprises:
a first registration means adapted to register goods from the first registration zone, and
a second registration means adapted to register goods from the second registration zone.

8. A checkout counter comprising:
a loading area,
a registration area comprising at least one means for motion detection and means for parallel checkout and registration of purchased goods where the means for parallel checkout and registration of purchased goods at least comprises:
at least one registration means adapted to register goods from the registration area, and
a packing area configured to receive goods from the registration area.

9. A checkout counter according to claim 8, where the registration area further comprises:
a first registration zone,
a second registration zone, and
at least one registration means adapted to register goods from the first and the second registration zone and
the packing area is configured to receive goods from two registration zones in parallel.

10. A checkout counter according to claim 8, where the registration area comprises at least two means for motion detection and where the at least two means for motion detection detect if a part of detecting zones on the registration area are interfered where the detecting zones partly overlap and creates combined detecting zones, and each detecting zone is associated with one of the at least two means for motion detection.

11. A checkout counter according to claim 8, where the loading area comprises a rotatable roundtable disc with at least one barrier arranged radially from the centre of the disc.

12. A checkout counter according to claim 8, where the packing area comprises a rotatable disc with at least one barrier arranged radially from the centre of the disc.

13. A checkout counter according to claim 8, wherein a motion detection area is divided into a first detection zone, a second detection zone and a third detection zone.

14. A checkout counter according to claim 13, where the first, second and third detection zones overlap to create combined detections zones.

15. Registration area of a checkout counter according to claim 2, further comprising a signal means indicating the status of registration using light signals, audio signals and/or the registration status is transferred to other systems (payment station/system), so that the customer and/or cashier and/or other required recipients of the information can access it.

16. Registration area of a checkout counter according to claim 2, the at least one means for motion detection is provided as one of or a combination of: passive infrared sensors, microwave detection sensors, ultrasonic sensors, Tomographic motion detector, video camera software, or laser light sensor.

17. Registration area of a checkout counter according to claim 2, where the registration area of the checkout counter comprises:
a first means for motion detection, and
a second means for motion detection.

18. Registration area of a checkout counter according to claim 2, comprising means for parallel checkout and registration of purchased goods where the means at least comprises:
a first registration zone,
a second registration zone, and
at least one registration means adapted to register goods from the first and the second registration zone.

19. Registration area of a checkout counter according to claim 2, wherein the registration area of the checkout counter comprises:
a first registration means adapted to register goods from the first registration zone, and
a second registration means adapted to register goods from the second registration zone.

20. A checkout counter according to claim 9, where the registration area comprises at least two means for motion detection and where the at least two means for motion detection detect if a part of detecting zones on the registration area are interfered where the detecting zones partly overlap and creates combined detecting zones, and each detecting zone is associated with one of the at least two means for motion detection.
